(19) United States
(12) Patent Application Publication
(10) Pub. No.: US 2025/0363382 A1
(43) Pub. Date: Nov. 27, 2025

(54) MULTI-TASK MODEL TRAINING METHOD AND DATA PROCESSING METHOD AND APPARATUSES, AND ELECTRONIC DEVICE

(71) Applicant: Lemon Inc., Grand Cayman (KY)

(72) Inventors: Yihan YANG, Los Angeles, CA (US); Rui LI, Los Angeles, CA (US); Xiangyu ZENG, Los Angeles, CA (US); Hongyu XIONG, Los Angeles, CA (US); Lingtong MENG, Beijing (CN); Zhen LIU, Beijing (CN)

(21) Appl. No.: 18/875,107

(22) PCT Filed: Jun. 7, 2023
(86) PCT No.: PCT/SG2023/050404

§ 371 Date: Dec. 13, 2024

(30) Foreign Application Priority Data
Jun. 15, 2022 (CN) 202210681514.2

(51) Int. Cl. G06N 3/094; G06N 3/045

(52) U.S. Cl. CPC G06N 3/094; G06N 3/045

(57) ABSTRACT

The present disclosure relates to a multi-task model training method, a data processing method, an electronic device and a storage medium. The multi-task model training method includes: obtaining training samples, where the training samples include an attribution data training sample and a non-attribution data training sample, and the training samples are constructed from conversion data corresponding to presented media content; processing the training samples through an attribution task and a non-attribution task in a multi-task model, to obtain a processing result corresponding to each task; and updating a shared parameter between the tasks in the multi-task model based on the processing result of the attribution task and the processing result of the non-attribution task, and updating an independent parameter corresponding to the attribution task based on the processing result of the attribution task.

The present application claims priority to Chinese Patent Application No. 202210681514.2, filed on Jun. 15, 2022, which is incorporated herein by reference in its entirety as a part of the present application.

### TECHNICAL FIELD

Embodiments of the present disclosure relate to a multi-task model training method and apparatus, a data processing method and apparatus, and an electronic device.

### BACKGROUND

In the related art, content presented by a content platform is closely related to a conversion rate of users. In order to achieve an expected conversion rate, it is necessary to reasonably select the presented content. In particular, when resources for content presentation are limited, the reasonable selection of delivered content is an important way of reducing resource consumption.

Estimation of a conversion rate typically requires modeling based on conversion data, which may be divided into attribution data and non-attribution data. The attribution data and non-attribution data do not cover exactly a same amount of information. If only one of the attribution data and non-attribution data is used for modeling, the other unused one may interfere with the learning of a model instead, which impairs the ability of the model to estimate the conversion rate; or if the modeling is performed using only information covered by both of the data, it is not possible to make full use of all the information, which also affects the ability of the model to estimate the conversion rate, resulting in a problem that more resources may be consumed to achieve an expected conversion rate.

Therefore, it is crucial to effectively use the attribution data and the non-attribution data for modeling to improve the accuracy of the model in estimating the conversion rate of content and thus to avoid waste of resources.

### SUMMARY

The Summary is provided to give a brief overview of concepts, which will be described in detail later in the section Detailed Description of Embodiments. The Summary is neither intended to identify key or necessary features of the claimed technical solutions, nor is it intended to be used to limit the scope of the claimed technical solutions.

According to a first aspect, the present disclosure provides a multi-task model training method. The method includes:
obtaining training samples, where the training samples include an attribution data training sample and a non-attribution data training sample, and the training samples are constructed from conversion data and non-conversion data corresponding to presented media content;
processing the training samples through an attribution task and a non-attribution task in a multi-task model, to obtain a processing result corresponding to each task; and
updating a shared parameter between the tasks in the multi-task model based on the processing result of the attribution task and the processing result of the non-attribution task, and updating an independent parameter corresponding to the attribution task based on the processing result of the attribution task.

According to a second aspect, the present disclosure provides a data processing method. The method includes:
obtaining content information of target content; and
processing the content information of the target content through an attribution task in a multi-task model to obtain a conversion rate of the target content, where the multi-task model is obtained through training according to the method of claim 1.

According to a third aspect, the present disclosure provides a multi-task model training apparatus. The apparatus includes:
a first obtaining module configured to obtain training samples, where the training samples include an attribution data training sample and a non-attribution data training sample, and the training samples are constructed from conversion data and non-conversion data corresponding to presented media content;
a first prediction module configured to process the training samples through an attribution task and a non-attribution task in a multi-task model, to obtain a processing result corresponding to each task; and
an update module configured to update a shared parameter between the tasks in the multi-task model based on the processing result of the attribution task and the processing result of the non-attribution task, and update an independent parameter corresponding to the attribution task based on the processing result of the attribution task.

According to a fourth aspect, the present disclosure provides a data processing apparatus. The apparatus includes:
a second obtaining module configured to obtain content information of target content; and
a second prediction module configured to process the content information of the target content through an attribution task in a multi-task model to obtain a conversion rate of the target content, where the multi-task model is obtained through training according to the method described in the first aspect.

According to a fifth aspect, the present disclosure provides a computer-readable medium having a computer program stored thereon, where the program, when executed by a processing apparatus, causes the steps of the method according to the first aspect to be implemented.

According to a sixth aspect, the present disclosure provides an electronic device. The electronic device includes:
a storage apparatus having a computer program stored thereon; and
a processing apparatus configured to execute the computer program in the storage apparatus to implement the steps of the method according to the first aspect.

With the above technical solutions, since the attribution data and the non-attribution data have different amounts of information, the multi-task model including the attribution task and the non-attribution task is built, the shared parameter between the tasks in the multi-task model is updated based on the processing result of the attribution task and the processing result of the non-attribution task, and the independent parameter of the attribution task is updated by using the processing result of the attribution task alone. In addition, since the non-attribution data corresponding to the non-attribution task has a relatively large amount of sample data, the generalization of a network layer corresponding to the shared parameter can be improved, and the accuracy of the processing result obtained by processing data through the attribution task that also has the shared parameter can be improved. This allows training for the attribution task to be assisted by means of the non-attribution task, and can minimize resource consumption while achieving an expected conversion rate.

The other features and advantages of the present disclosure will be described in detail in the following section Detailed Description of Embodiments.

### BRIEF DESCRIPTION OF DRAWINGS

The above and other features, advantages, and aspects of the embodiments of the present disclosure will become more apparent in conjunction with the accompanying drawings and with reference to the following specific embodiments. Throughout the accompanying drawings, identical or similar reference numerals denote identical or similar elements. It should be understood that the accompanying drawings are schematic, and the components and elements are not necessarily drawn to scale.

FIG. 1 is a flowchart of a multi-task model training method according to an exemplary embodiment of the present disclosure;

FIG. 2 is a schematic diagram of a model structure of a multi-task model according to an exemplary embodiment of the present disclosure;

FIG. 3 is a schematic diagram of updating parameters corresponding to network layers in a multi-task model according to an exemplary embodiment of the present disclosure;

FIG. 4 is a flowchart of a data processing method according to an exemplary embodiment of the present disclosure;

FIG. 5 is a block diagram of a multi-task model training apparatus according to an exemplary embodiment of the present disclosure;

FIG. 6 is a block diagram of a data processing apparatus according to an exemplary embodiment of the present disclosure; and

FIG. 7 is a schematic diagram of a structure of an electronic device according to an exemplary embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from a user, prompt information is sent to the user to clearly inform the user that a requested operation will require access to and use of personal information of the user. As such, the user can independently choose, based on the prompt information, whether to provide the personal information to software or hardware, such as an electronic device, an application, a server, or a storage medium, that performs the operations of the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It can be understood that the above process of notifying and obtaining user authorization is only illustrative and does not constitute a limitation on the implementations of the present disclosure, and other manners that satisfy the relevant laws and regulations may also be applied in the implementations of the present disclosure.

Furthermore, it can be understood that the data involved in the technical solutions (including, but not limited to, the data itself and the access to or use of the data) shall comply with the requirements of corresponding laws, regulations, and relevant provisions.

Attribution data refers to data indicating that content is presented on a content platform and that a conversion behavior (e.g., subscription, download, and other behaviors) is attributed to the content presented on the content platform, and non-attribution data refers to data indicating that content is presented on the content platform and that a conversion behavior (e.g., subscription, download, and other behaviors) is attributed to other presented content (which may be presented on the above-mentioned content platform, or may be presented on another content platform). For the content platform, compared with the non-attribution data, the attribution data (in particular data related to a deep-level conversion behavior, for example, subscription, download, and other behaviors of a user) is very sparse, which severely limits the performance of a machine learning model. Here, the performance means the accuracy of determining a conversion rate of content. If the conversion rate of content cannot be estimated, a problem may occur that more resources may be consumed to achieve an expected conversion rate. Therefore, in order to improve the accuracy of the model in estimating the conversion rate of content and thus to avoid waste of resources, it is necessary to make full use of both the attribution data and the non-attribution data.

As mentioned in the Background Art, the content platform does not have exactly the same amount of information about the attribution data and the non-attribution data. For example, for an attribution conversion behavior, the content platform may know a presentation time of content that triggers the conversion behavior, information about a device on which the content is presented, context information of the content, etc. However, for a non-attribution conversion behavior, these types of information are unavailable to the content platform. Therefore, separate modeling on both of the data in the same way cannot effectively improve the ability of the model to estimate the conversion rate. That is, if only one of the attribution data and non-attribution data is used for modeling, the other unused one may interfere with the learning of a model instead, which impairs the ability of the model to estimate the conversion rate; or if the modeling is performed using only information covered by both of the data, it is not possible to make full use of all the information, which also affects the ability of the model to estimate the conversion rate.

In view of this, an embodiment of the present disclosure provides a multi-task model training method that allows training for the attribution task to be assisted by means of the non-attribution task in a multi-task training manner, thereby effectively improving the ability of the model to accurately estimate the conversion rate of content, so that the problem that more resources are consumed to achieve an expected user conversion rate when content with an actual low conversion rate is presented can be avoided.

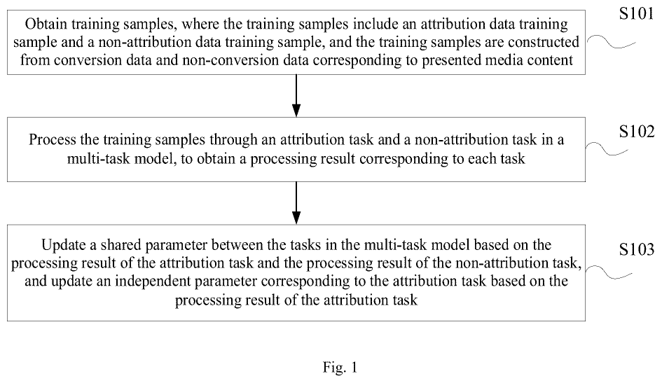

FIG. 1 is a flowchart of a multi-task model training method according to an exemplary embodiment of the present disclosure. The multi-task model training method may be applied, for example, to an electronic device such as a smartphone or a tablet computer. Referring to FIG. 1, the multi-task model training method includes the following steps.

Step S101: Obtain training samples, where the training samples include an attribution data training sample and a non-attribution data training sample, and the training samples are constructed from conversion data and non-conversion data corresponding to presented media content.

For example, the training samples may be data obtained from a same content presentation platform after different content is presented thereon, or may be data obtained from different content presentation platforms after different content is presented thereon, which is not limited in this embodiment. If the data is obtained from the different content presentation platforms, it is necessary to first obtain authorization from the respective third-party content platforms.

For example, the training samples may be data obtained in different time periods, so that the generalization of the training samples can be ensured, thereby improving the generalization of a trained model.

The attribution data training sample includes a positive sample and a negative sample, where the positive sample may represent data that triggers a conversion, and the data indicates that media content is presented on a first presentation platform and that a conversion behavior of the media content is attributed to conversion data on the first presentation platform; and the negative sample may represent data that does not trigger a conversion, and the data indicates that media content is presented on the first presentation platform and that a non-conversion behavior of the media content is attributed to non-conversion data on the first presentation platform. Similar to the attribution data training sample, the non-attribution data training sample also includes a positive sample and a negative sample, where the positive sample may represent data that triggers a conversion, and the data indicates that if media content is presented on the first presentation platform, a conversion behavior of the media content is attributed to conversion data on a second presentation platform on which media content is also presented; and the negative sample may represent data that does not trigger a conversion, and the data indicates that if media content is presented on the first presentation platform, a non-conversion behavior of the media content is attributed to non-conversion data on the second presentation platform on which media content is also presented. The media content presented on the second presentation platform is related to the media content presented on the first presentation platform, and the first presentation platform is different from the second presentation platform.

Step S102: Process the training samples through an attribution task and a non-attribution task in a multi-task model, to obtain a processing result corresponding to each task.

It should be noted that the multi-task model is a model obtained by modeling a plurality of similar tasks together. Similarities and differences between the individual tasks are used to improve the accuracy and generalization of the model, thereby improving the performance of the model.

In this embodiment, the multi-task model includes the attribution task and the non-attribution task. After the training samples are processed through the attribution task and the non-attribution task in the multi-task model, two processing results may be obtained, one of which is a processing result that is of whether a conversion occurs and that corresponds to the attribution task, and the other is a processing result that is of whether a conversion occurs and that corresponds to the non-attribution task.

Step S103: Update a shared parameter between the tasks in the multi-task model based on the processing result of the attribution task and the processing result of the non-attribution task, and update an independent parameter corresponding to the attribution task based on the processing result of the attribution task.

The attribution task in the trained multi-task model is used to predict a conversion rate of target content. The target content may be, for example, media content, and the target content includes content information such as text and pictures used to represent target content that needs to be presented on the content platform, which is not limited here in this embodiment. In actual applications, target content with a high conversion rate is selected for presentation. In this way, presentation of content with a low conversion rate is avoided, which avoids a case in which the expected conversion rate cannot be achieved with limited delivery resources due to delivery of the content with a low conversion rate. Here, the resources may be a time for which content is delivered on the content presentation platform, which is equivalent to content display resources of the content presentation platform.

In this way, since the attribution data and the non-attribution data have different amounts of information, the multi-task model including the attribution task and the non-attribution task is built, the shared parameter between the tasks in the multi-task model is updated based on the processing result of the attribution task and the processing result of the non-attribution task, and the independent parameter of the attribution task is updated by using the processing result of the attribution task alone. Since the non-attribution data corresponding to the non-attribution task has a relatively large amount of sample data, the generalization of a network layer corresponding to the shared parameter can be improved, and the estimation performance of the attribution task that also has the shared parameter can be improved. This allows training for the attribution task to be assisted by means of the non-attribution task, and can minimize resource consumption while achieving an expected conversion rate.

In some embodiments, the attribution task and the non-attribution task include a plurality of network layer structures, where the plurality of network layer structures generally include a feature network layer involving feature extraction and a calculation network layer involving result calculation. Therefore, in this case, network layers in the plurality of network layer structures included in the attribution task and the non-attribution task may be updated through backpropagation. In particular, the backpropagation method is a method in which a loss is calculated by using a processing result and a sample label, a parameter of the calculation network layer is first updated based on the loss, and then a parameter of the feature network layer is updated based on the updated parameter of the calculation network layer.

In actual applications, in a case where a difference in distributions of the attribution data and the non-attribution data is significant, if the shared parameter between the tasks in the multi-task model is updated by combining the processing result of the attribution task and the processing result of the non-attribution task, the update of the independent parameter in the attribution task may be affected greatly. Therefore, in order to allow training for the attribution task to be assisted by means of the non-attribution task while avoiding affecting learning of the attribution task, the step of updating the shared parameter between the tasks in the multi-task model based on the processing result of the attribution task and the processing result of the non-attribution task as shown in FIG. 1 may be implemented by updating the shared parameter between the tasks in the multi-task model based on the processing result of the non-attribution task.

In this way, only the processing result of the non-attribution task is used to update the shared parameter between the tasks in the multi-task model, and the network layer corresponding to the shared parameter is trained in a stop-gradient training manner during training of the attribution task. In the case where a difference in distributions of the attribution data and the non-attribution data is relatively large, this prevents learning of the attribution task from being affected by the non-attribution task, thereby allowing training for the attribution task to be assisted by means of the non-attribution task while preventing the non-attribution task from affecting learning of the attribution task.

In some embodiments, in order to use the non-attribution data to focus on strengthening learning of the model for deep-level events, a definition may be made for selection of a positive sample and a negative sample for a task. First, a shallow-level event and a deep-level event are illustrated using an example. For example, a conversion is generated by a series of chronological actions (hereinafter referred to as events). The series of events may include a viewing event (which may be understood as a user viewing the presented media content on the content platform), a click event (which may be understood as clicking on the media content), an installation event (which may be understood as installing an application corresponding to the clicked media content), a registration event (which may be understood as becoming a registered user of the application), a payment event (which may be understood as purchasing a product in the application), and other events. Here, an event that happens earlier among the series of events may be referred to as a shallow-level event, and an event that happens later may be referred to as a deep-level event. A node for separating the deep-level event and the shallow-level event in the attribution task is different from that in the non-attribution task. Therefore, in an embodiment, the non-attribution task may be built by using a shallow-level event (which may be understood as the viewing event) instead of the click event in the non-attribution data as the negative sample and using a deep-level event (which may be understood as an event after the viewing event) as the positive sample, while the attribution task is built by using a shallow-level event (such as the click event and the viewing event) as the negative sample and using all deep-level events (i.e., a conversion event, such as the installation event, and the registration event, the payment event, and other events following the installation event) as the positive sample. In this way, the non-attribution data can be used to focus on strengthening the learning of the model for the deep-level events.

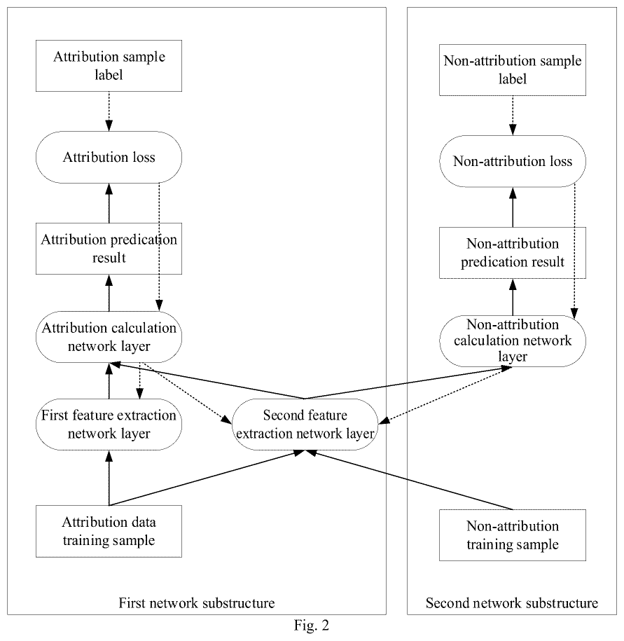

FIG. 2 is a schematic diagram of a model structure of a multi-task model according to an exemplary embodiment of the present disclosure. Referring to FIG. 2, the multi-task model includes a first network substructure corresponding to the attribution task and a second network substructure corresponding to the non-attribution task, the first network substructure includes a first feature extraction network layer, a second feature extraction network layer, and an attribution calculation network layer, the second network substructure includes the second feature extraction network layer and a non-attribution calculation network layer, a network parameter corresponding to the first feature extraction network layer is the independent parameter, and a network parameter corresponding to the second feature extraction network layer is the shared parameter.

It should be noted that the second feature extraction network layer shared by the first network substructure and the second network substructure is only illustrated in the first network substructure as shown in FIG. 2, but it should be understood that the second network substructure also includes the second feature extraction network layer shown in FIG. 2. In addition, a solid arrow in FIG. 2 represents a direction of a data flow for processing training samples through the tasks; and a dashed arrow in FIG. 2 represents a direction of an update flow of the parameters corresponding to the network layers based on the processing results of the tasks (i.e., the backpropagation method).

An exemplary description of step S102 shown in FIG. 1 is given below with reference to FIG. 2.

For the attribution task, step S102 shown in FIG. 1 may be implemented by performing, by the first feature extraction network layer, feature vector extraction on target data in the attribution data training sample and the non-attribution data training sample to obtain a first feature vector; performing, by the second feature extraction network layer, feature vector extraction on common data in the attribution data training sample and the non-attribution data training sample to obtain a second feature vector; and processing, by the attribution calculation network layer, the first feature vector and the second feature vector to obtain the processing result corresponding to the attribution task.

In some embodiments, the target data may include data in the attribution data training sample except for data included in the non-attribution data training sample, i.e., information specific to the attribution data training sample. In this way, more attention may be paid to the information specific to the attribution data training sample, so that the update of the independent parameter corresponding to the attribution task is only subject to the information specific to the attribution data training sample.

For example, the information specific to the attribution data training sample may include, for example, the presentation time of content in the attribution data training sample, the information about a device on which the content is presented, the context information of the content, etc., as mentioned above.

In some embodiments, in addition to the data in the attribution data training sample except for the data included in the non-attribution data training sample, the target data may include the common data in the attribution data training sample and the non-attribution data training sample. It should be noted that the common data is a type of data that both the attribution data training sample and the non-attribution data training sample have. In this way, more information covered by the attribution data training sample may be obtained to make the independent parameter corresponding to the attribution task more generalized.

For example, the common data may include data on an entity side (e.g., an application) corresponding to the media content presented on the content platform, for example, developer information, field information, ratings, and other types of data on the entity side, and may further include data on a user side corresponding to the content platform, such as user preference characteristics.

For the non-attribution task, step S102 shown in FIG. 1 may be implemented by processing, by the attribution calculation network layer, the second feature vector to obtain the processing result corresponding to the non-attribution task.

It should be noted that the attribution calculation network layer calculates a probability that a conversion occurs and a probability that a conversion does not occur. In an implementation, if the probability that a conversion occurs is greater than the probability that a conversion does not occur, it may be determined that a prediction result is the conversion occurs. The probability here represents the extent to which the conversion occurs (or the conversion does not occur). Similarly, the non-attribution calculation network layer also calculates a probability that a conversion occurs and a probability that a conversion does not occur.

An exemplary description of inputs and outputs of the network layers in the tasks and of an update process of the parameters corresponding to the network layers in the tasks is given below with reference to FIG. 2.

The first feature vector extracted by the first feature extraction network layer and the second feature vector extracted by the second feature extraction network layer are concatenated and input into the attribution calculation network layer. The attribution calculation network layer calculates the input feature vectors to obtain the attribution processing result corresponding to the attribution task. Based on the attribution processing result and an attribution sample label in the attribution data training sample, an attribution loss is determined. Based on the attribution loss, a network parameter corresponding to the attribution calculation network layer is first updated. Based on the updated network parameter, the independent parameter corresponding to the first feature extraction network layer and the shared parameter corresponding to the second feature extraction network layer are updated. At the same time, the second feature vector extracted by the second feature extraction network layer is input into the non-attribution calculation network layer. The non-attribution calculation network layer calculates the input feature vector to obtain the non-attribution processing result corresponding to the non-attribution task. Based on the non-attribution processing result and a non-attribution sample label in the non-attribution data training sample, a non-attribution loss is determined. Based on the non-attribution loss, a network parameter corresponding to the non-attribution calculation network layer is first updated. Then, based on the updated network parameter, the shared parameter corresponding to the second feature extraction network layer is updated.

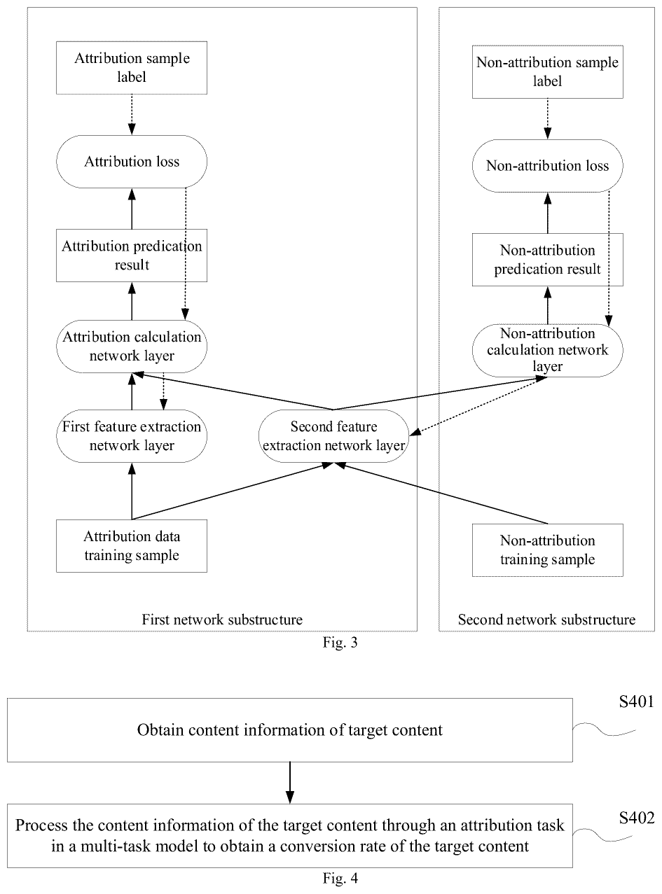

It should be noted that, as mentioned above, the shared parameter may be updated only using the processing result of the non-attribution task. Referring to FIG. 3, the network parameter corresponding to the attribution calculation network layer is first updated based on the attribution loss, and then the independent parameter corresponding to the first feature extraction network layer is updated based on the updated network parameter. In FIG. 3, there is no dashed arrow from the attribution calculation network layer to the second feature extraction network layer, which means that there is no further need to update the shared parameter corresponding to the second feature extraction network layer based on the updated network parameter, and the shared parameter corresponding to the second feature extraction network layer only needs to be updated using the non-attribution loss. In the case where a difference in distributions of the attribution data and the non-attribution data is relatively large, this prevents learning of the attribution task from being affected by the non-attribution task, thereby allowing training for the attribution task to be assisted by means of the non-attribution task while preventing the non-attribution task from affecting learning of the attribution task.

In some embodiments, the first feature vector and the second feature vector may be embedding vectors. The embedding vectors are used to represent original data in a model by converting original discrete values into a low-dimensional real-value vector, and retain a logical relationship between pieces of the original data as much as possible. Compared with a one-hot encoding method for representing the original data, the embedding vectors can reduce a vector dimensionality, thereby reducing the size of a structure of the model, accelerating the convergence capability of the model, and improving the estimation performance of the model.

Based on the same inventive concept, an embodiment of the present disclosure provides a data processing method, which may be applied to an electronic device. Referring to FIG. 4, the method includes:
step S401: obtaining content information of target content; and
step S402: processing the content information of the target content through an attribution task in a multi-task model to obtain a conversion rate of the target content, where the multi-task model is obtained through training according to the multi-task model training method mentioned in the above embodiment. A first feature extraction network layer in an attribution task in the multi-task model extracts a first feature vector corresponding to the content information of the target content. Then, a second feature extraction network layer extracts a second feature vector corresponding to the content information of the target content. An attribution calculation network layer processes a concatenated vector of the first feature vector and the second feature vector to obtain a conversion rate of the target content. The conversion rate is used to represent a probability that a conversion behavior may be triggered after a content platform presents the target content. It should be understood that the content platform may present target content with a higher probability, so that it can push an advertisement to the user more accurately, thereby improving the conversion rate and minimizing resource consumption while achieving an expected conversion rate.

It should be note that for the type of the content information of the target content, reference may be made to the forgoing related embodiments in which the data types of the training samples are described, which is not repeated here in this embodiment.

Continuing with the above example, the target content may be the media content, such as an advertisement. The electronic device obtains content information of an advertisement that may be presented on a device with a display screen, and processes the content information of the advertisement through an attribution task in a multi-task model carried on the electronic device, to obtain a conversion rate of the advertisement. If the conversion rate is greater than a preset threshold, the advertisement may be presented online. In this way, a high user conversion rate in an advertising application scenario can be ensured with limited resources for content presentation, and the waste of the content display resources can be reduced.

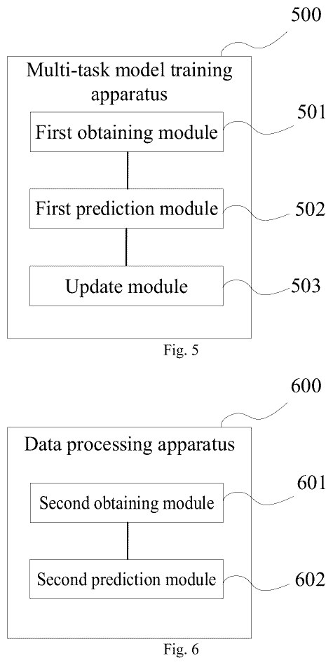

Based on the same inventive concept, an embodiment of the present disclosure provides a multi-task model training apparatus. Referring to FIG. 5, the multi-task model training apparatus 500 includes: a first obtaining module 501 configured to obtain training samples, where the training samples include an attribution data training sample and a non-attribution data training sample, and the training samples are constructed from conversion data and non-conversion data corresponding to presented media content; a first prediction module 502 configured to process the training samples through an attribution task and a non-attribution task in a multi-task model, to obtain a processing result corresponding to each task; and an update module 503 configured to update a shared parameter between the tasks in the multi-task model based on the processing result of the attribution task and the processing result of the non-attribution task, and update an independent parameter corresponding to the attribution task based on the processing result of the attribution task.

Optionally, the update module 503 includes:
a first update submodule configured to update the shared parameter between the tasks in the multi-task model based on the processing result of the non-attribution task.

Optionally, the multi-task model includes a first network substructure corresponding to the attribution task and a second network substructure corresponding to the non-attribution task, the first network substructure includes a first feature extraction network layer, a second feature extraction network layer, and an attribution calculation network layer, the second network substructure includes the second feature extraction network layer and a non-attribution calculation network layer, a network parameter corresponding to the first feature extraction network layer is the independent parameter, and a network parameter corresponding to the second feature extraction network layer is the shared parameter.

Optionally, for the attribution task, the first prediction module 502 includes:
a first vector extraction submodule configured to perform, by the first feature extraction network layer, feature vector extraction on target data in the attribution data training sample and the non-attribution data training sample to obtain a first feature vector, where the target data includes data in the attribution data training sample except for data included in the non-attribution data training sample;
a second vector extraction submodule configured to perform, by the second feature extraction network layer, feature vector extraction on common data in the attribution data training sample and the non-attribution data training sample to obtain a second feature vector; and
a first prediction submodule configured to process, by the attribution calculation network layer, the first feature vector and the second feature vector to obtain the processing result corresponding to the attribution task.

Optionally, the target data further includes the common data in the attribution data training sample and the non-attribution data training sample.

Optionally, for the non-attribution task, the first prediction module 502 further includes:
a second prediction submodule configured to process, by the non-attribution calculation network layer, the second feature vector to obtain the processing result corresponding to the non-attribution task.

Based on the same inventive concept, an embodiment of the present disclosure provides a data processing apparatus. Referring to FIG. 6, the data processing apparatus 600 includes:
a second obtaining module 601 configured to obtain content information of target content; and
a second prediction module 602 configured to process the content information of the target content through an attribution task in a multi-task model to obtain a conversion rate of the target content, where the multi-task model is obtained through training according to the method according to the first aspect.

With respect to the apparatuses in the above embodiments, the specific manner in which each module performs an operation has been described in detail in the embodiments relating to the methods, and will not be detailed herein.

Based on the same inventive concept, an embodiment of the present disclosure provides a computer-readable medium having a computer program stored thereon, where the program, when executed by a processing apparatus, causes the steps of the method described in the above embodiment to be implemented.

Based on the same inventive concept, an embodiment of the present disclosure provides an electronic device. The electronic device includes:
a storage apparatus having a computer program stored thereon; and
a processing apparatus configured to execute the computer program in the storage apparatus to implement the steps of the methods described in the above embodiments.

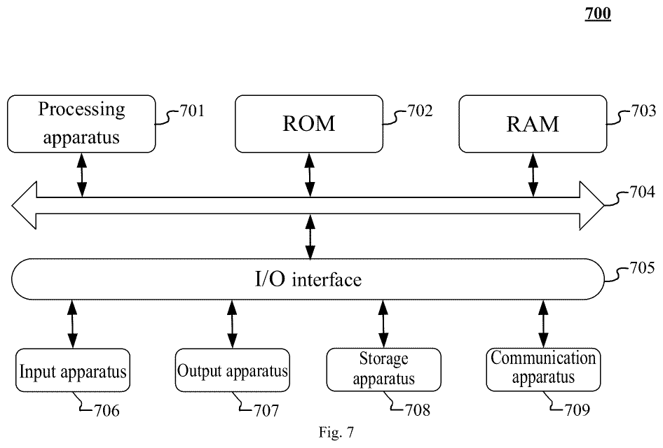

Reference is made to FIG. 7 below, which is a schematic diagram of a structure of an electronic device 700 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 7 is merely an example, and shall not impose any limitation on the function and scope of use of the embodiments of the present disclosure.

As shown in FIG. 7, the electronic device 700 may include a processing apparatus (e.g., a central processing unit, a graphics processing unit, etc.) 701 that may perform a variety of appropriate actions and processing in accordance with a program stored in a read-only memory (ROM) 702 or a program loaded from a storage apparatus 708 into a random access memory (RAM) 703. The RAM 703 further stores various programs and data required for the operation of the electronic device 700. The processing apparatus 701, the ROM 702, and the RAM 703 are connected to each other through a bus 704. An input/output (I/O) interface 705 is also connected to the bus 704.

Generally, the following apparatuses may be connected to the I/O interface 705: an input apparatus 706 including, for example, a touch screen, a touchpad, a keyboard, a mouse, a camera, a microphone, an accelerometer, and a gyroscope; an output apparatus 707 including, for example, a liquid crystal display (LCD), a speaker, and a vibrator; the storage apparatus 708 including, for example, a tape and a hard disk; and a communication apparatus 709. The communication apparatus 709 may allow the electronic device 700 to perform wireless or wired communication with other devices to exchange data. Although FIG. 7 shows the electronic device 700 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 709 and installed, installed from the storage apparatus 708, or installed from the ROM 702. When the computer program is executed by the processing apparatus 701, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to electric wires, optical cables, radio frequency (RF), etc., or any suitable combination thereof.

In some implementations, the electronic device may communicate using any currently known or future-developed network protocol such as a HyperText Transfer Protocol (HTTP), and may be connected to digital data communication (for example, communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: obtain training samples, where the training samples include an attribution data training sample and a non-attribution data training sample, and the training samples are constructed from conversion data and non-conversion data corresponding to presented media content; process the training samples through an attribution task and a non-attribution task in a multi-task model, to obtain a processing result corresponding to each task; and update a shared parameter between the tasks in the multi-task model based on the processing result of the attribution task and the processing result of the non-attribution task, and update an independent parameter corresponding to the attribution task based on the processing result of the attribution task.

The computer program code for performing the operations of the present disclosure may be written in one or more programming languages or a combination thereof, where the programming languages include, but are not limited to, an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The modules described in the embodiments of the present disclosure may be implemented by software, or may be implemented by hardware. Names of the modules do not constitute a limitation on the modules in some cases. For example, the first obtaining module may alternatively be described as “a module for obtaining training samples”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

According to one or more embodiments of the present disclosure, Example 1 provides a multi-task model training method, and the method includes:
obtaining training samples, where the training samples include an attribution data training sample and a non-attribution data training sample, and the training samples are constructed from conversion data and non-conversion data corresponding to presented media content;
processing the training samples through an attribution task and a non-attribution task in a multi-task model, to obtain a processing result corresponding to each task; and
updating a shared parameter between the tasks in the multi-task model based on the processing result of the attribution task and the processing result of the non-attribution task, and updating an independent parameter corresponding to the attribution task based on the processing result of the attribution task.

According to one or more embodiments of the present disclosure, Example 2 provides the method of Example 1, where the updating a shared parameter between the tasks in the multi-task model based on the processing result of the attribution task and the processing result of the non-attribution task includes: updating the shared parameter between the tasks in the multi-task model based on the processing result of the non-attribution task.

According to one or more embodiments of the present disclosure, Example 3 provides the method of Example 1, where the multi-task model includes a first network substructure corresponding to the attribution task and a second network substructure corresponding to the non-attribution task, the first network substructure includes a first feature extraction network layer, a second feature extraction network layer, and an attribution calculation network layer, the second network substructure includes the second feature extraction network layer and a non-attribution calculation network layer, a network parameter corresponding to the first feature extraction network layer is the independent parameter, and a network parameter corresponding to the second feature extraction network layer is the shared parameter.

According to one or more embodiments of the present disclosure, Example 4 provides the method of Example 3, where for the attribution task, the processing the training samples through an attribution task and a non-attribution task in a multi-task model, to obtain a processing result corresponding to each task includes:
performing, by the first feature extraction network layer, feature vector extraction on target data in the attribution data training sample and the non-attribution data training sample to obtain a first feature vector, where the target data includes data in the attribution data training sample except for data included in the non-attribution data training sample;
performing, by the second feature extraction network layer, feature vector extraction on common data in the attribution data training sample and the non-attribution data training sample to obtain a second feature vector; and
processing, by the attribution calculation network layer, the first feature vector and the second feature vector to obtain the processing result corresponding to the attribution task.

According to one or more embodiment of the present disclosure, Example 5 provides the method of Example 4, where the target data further includes the common data in the attribution data training sample and the non-attribution data training sample.

According to one or more embodiments of the present disclosure, Example 6 provides the method of Example 4, where for the non-attribution task, the processing the training samples through an attribution task and a non-attribution task in a multi-task model, to obtain a processing result corresponding to each task includes:
processing, by the non-attribution calculation network layer, the second feature vector to obtain the processing result corresponding to the non-attribution task.

According to one or more embodiments of the present disclosure, Example 7 provides a data processing method, and the method includes:
obtaining content information of target content; and
processing the content information of the target content through an attribution task in a multi-task model to obtain a conversion rate of the target content, where the multi-task model is obtained through training according to the method of Example 1.

According to one or more embodiments of the present disclosure, Example 8 provides a multi-task model training apparatus, and the apparatus includes:

a first obtaining module configured to obtain training samples, where the training samples include an attribution data training sample and a non-attribution data training sample, and the training samples are constructed from conversion data and non-conversion data corresponding to presented media content;
a first prediction module configured to process the training samples through an attribution task and a non-attribution task in a multi-task model, to obtain a processing result corresponding to each task; and
an update module configured to update a shared parameter between the tasks in the multi-task model based on the processing result of the attribution task and the processing result of the non-attribution task, and update an independent parameter corresponding to the attribution task based on the processing result of the attribution task.

According to one or more embodiments of the present disclosure, Example 9 provides a data processing apparatus, and the apparatus includes:
a second obtaining module configured to obtain content information of target content; and
a second prediction module configured to process the content information of the target content through an attribution task in a multi-task model to obtain a conversion rate of the target content, where the multi-task model is obtained through training according to the method of Example 1.

According to one or more embodiments of the present disclosure, Example 10 provides a computer-readable medium having a computer program stored thereon, where the program, when executed by a processing apparatus, causes the steps of the method according to any one of Examples 1 to 7 to be implemented.

According to one or more embodiments of the present disclosure, Example 11 provides an electronic device, and the electronic device includes:
a storage apparatus having a computer program stored thereon; and
a processing apparatus configured to execute the computer program in the storage apparatus to implement the steps of the method according to any one of Examples 1 to 7.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should be understood as requiring these operations to be performed in the specific order shown or in a sequential order. Under certain circumstances, multi-tasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims. With respect to the apparatuses in the above embodiments, the specific manner in which each module performs an operation has been described in detail in the embodiments relating to the methods, and will not be detailed herein.

1. A multi-task model training method, comprising:
obtaining training samples, wherein the training samples comprise an attribution data training sample and a non-attribution data training sample, and the training samples are constructed from conversion data and non-conversion data corresponding to presented media content;
processing the training samples through an attribution task and a non-attribution task in a multi-task model, to obtain a processing result corresponding to each task; and
updating a shared parameter between the tasks in the multi-task model based on the processing result of the attribution task and the processing result of the non-attribution task, and updating an independent parameter corresponding to the attribution task based on the processing result of the attribution task.

2. The method according to claim 1, wherein the updating a shared parameter between the tasks in the multi-task model based on the processing result of the attribution task and the processing result of the non-attribution task comprises:
updating the shared parameter between the tasks in the multi-task model based on the processing result of the non-attribution task.

3. The method according to claim 1, wherein the multi-task model comprises a first network substructure corresponding to the attribution task and a second network substructure corresponding to the non-attribution task, the first network substructure comprises a first feature extraction network layer, a second feature extraction network layer, and an attribution calculation network layer, the second network substructure comprises the second feature extraction network layer and a non-attribution calculation network layer, a network parameter corresponding to the first feature extraction network layer is the independent parameter, and a network parameter corresponding to the second feature extraction network layer is the shared parameter.

4. The method according to claim 3, wherein for the attribution task, the processing the training samples through an attribution task and a non-attribution task in a multi-task model, to obtain a processing result corresponding to each task comprises:
performing, by the first feature extraction network layer, feature vector extraction on target data in the attribution data training sample and the non-attribution data training sample to obtain a first feature vector, wherein the target data comprises data in the attribution data training sample except for data comprised in the non-attribution data training sample;
performing, by the second feature extraction network layer, feature vector extraction on common data in the attribution data training sample and the non-attribution data training sample to obtain a second feature vector; and
processing, by the attribution calculation network layer, the first feature vector and the second feature vector to obtain the processing result corresponding to the attribution task.

5. The method according to claim 4, wherein the target data further comprises the common data in the attribution data training sample and the non-attribution data training sample.

6. The method according to claim 4, wherein for the non-attribution task, the processing the training samples through an attribution task and a non-attribution task in a multi-task model, to obtain a processing result corresponding to each task comprises:
processing, by the non-attribution calculation network layer, the second feature vector to obtain the processing result corresponding to the non-attribution task.

7. A data processing method, comprising:
obtaining content information of target content; and
processing the content information of the target content through an attribution task in a multi-task model to obtain a conversion rate of the target content, wherein the multi-task model is obtained through training according to a multi-task model training method, and the multi-task model training method comprises:
obtaining training samples, wherein the training samples comprise an attribution data training sample and a non-attribution data training sample, and the training samples are constructed from conversion data and non-conversion data corresponding to presented media content;
processing the training samples through an attribution task and a non-attribution task in a multi-task model, to obtain a processing result corresponding to each task; and
updating a shared parameter between the tasks in the multi-task model based on the processing result of the attribution task and the processing result of the non-attribution task, and updating an independent parameter corresponding to the attribution task based on the processing result of the attribution task.

8. (canceled)

9. (canceled)

10. A non-transitory computer-readable medium having a computer program stored thereon, wherein the computer program, when executed by a processing apparatus, causes the multi-task model training method according to claim 1 to be implemented.

11. An electronic device, comprising:
a storage apparatus having a computer program stored thereon; and
a processing apparatus configured to execute the computer program in the storage apparatus to implement a multi-task model training method, and the multi-task model training method comprises:
obtaining training samples, wherein the training samples comprise an attribution data training sample and a non-attribution data training sample, and the training samples are constructed from conversion data and non-conversion data corresponding to presented media content;
processing the training samples through an attribution task and a non-attribution task in a multi-task model, to obtain a processing result corresponding to each task; and
updating a shared parameter between the tasks in the multi-task model based on the processing result of the attribution task and the processing result of the non-attribution task, and updating an independent parameter corresponding to the attribution task based on the processing result of the attribution task.

12. A non-transitory computer-readable medium having a computer program stored thereon, wherein the computer program, when executed by a processing apparatus, causes the processing method according to claim 7 to be implemented.

13. The electronic device according to claim 11, wherein the updating a shared parameter between the tasks in the multi-task model based on the processing result of the attribution task and the processing result of the non-attribution task comprises:
updating the shared parameter between the tasks in the multi-task model based on the processing result of the non-attribution task.

14. The electronic device according to claim 11, wherein the multi-task model comprises a first network substructure corresponding to the attribution task and a second network substructure corresponding to the non-attribution task, the first network substructure comprises a first feature extraction network layer, a second feature extraction network layer, and an attribution calculation network layer, the second network substructure comprises the second feature extraction network layer and a non-attribution calculation network layer, a network parameter corresponding to the first feature extraction network layer is the independent parameter, and a network parameter corresponding to the second feature extraction network layer is the shared parameter.

15. The electronic device according to claim 14, wherein for the attribution task, the processing the training samples through an attribution task and a non-attribution task in a multi-task model, to obtain a processing result corresponding to each task comprises:
performing, by the first feature extraction network layer, feature vector extraction on target data in the attribution data training sample and the non-attribution data training sample to obtain a first feature vector, wherein the target data comprises data in the attribution data training sample except for data comprised in the non-attribution data training sample;
performing, by the second feature extraction network layer, feature vector extraction on common data in the attribution data training sample and the non-attribution data training sample to obtain a second feature vector; and
processing, by the attribution calculation network layer, the first feature vector and the second feature vector to obtain the processing result corresponding to the attribution task.

16. The electronic device according to claim 15, wherein the target data further comprises the common data in the attribution data training sample and the non-attribution data training sample.

17. The electronic device according to claim 15, wherein for the non-attribution task, the processing the training samples through an attribution task and a non-attribution task in a multi-task model, to obtain a processing result corresponding to each task comprises:
processing, by the non-attribution calculation network layer, the second feature vector to obtain the processing result corresponding to the non-attribution task.
